(19) United States
(12) Patent Application Publication
(10) Pub. No.: US 2009/0035723 A1
(43) Pub. Date: Feb. 5, 2009

(54) MATERIAL WITH A REPETITIVE PATTERN OF MICRO-FEATURES FOR APPLICATION IN A LIVING ORGANISM AND METHOD OF FABRICATION

(76) Inventors: Claus Daniel, Knoxville, TN (US); Narendra B. Dahotre, Knoxville, TN (US)

Correspondence Address: ORNL-UTB-LUEDEKA, NEELY & GRAHAM, P.O. BOX 1871, KNOXVILLE, TN, 37901, US

(21) Appl. No.: 11/833,732

(22) Filed: Aug. 3, 2007

(51) Int. Cl. A61C 5/00

(52) U.S. Cl. 433/215

(57) ABSTRACT

A material configured for implantation in a living organism. In some embodiments, the material includes a mechanical surface that has long range ordered micro-features. A repetitive pattern of hierarchical micro-features is incorporated in some embodiments, and in some embodiments the micro-features are composite in nature, and may include nano-structures. One embodiment provides a method of modifying the surface of a tissue in a living organism. The method includes a step of dividing a laser beam into a plurality of laser beams and a further step of guiding the plurality of laser beams to create an interference pattern at the surface of the material, and a repetitive pattern of micro-features is formed on the surface of the tissue.

### GOVERNMENT RIGHTS

This invention was made with government support under Contract No. DE-AC05-00OR22725 awarded by the U.S. Department of Energy. The government has certain rights in the invention.

### FIELD

This disclosure relates to the field of implants. More particularly, this disclosure relates to implant materials that have periodic structured surfaces at the micro- and nano-scale.

### BACKGROUND

Replacement of defective bone and bone-like material in humans is a practice that has evolved over many years. Most likely the oldest type of such restoration is in dentistry where broken or missing teeth are repaired with artificial implants. Modern composite dental implants are often composed of alumina, zirconia, porcelain, or a similar material. Alumina has the benefit of being bio-inert in many applications. However, the strength and toughness of alumina may be inadequate in highly stressed applications. Fully-stabilized zirconia has excellent physical properties; however, its high coefficient of thermal expansion may result in thermal fatigue failures. Partially-stabilized zirconia formulations have been developed to address that shortcoming, but the aesthetic appearance of zirconia materials is unacceptable for many patients. Porcelain is often used as a veneer to improve the aesthetic appearance of the implant. Dental implants are often affixed to posts that are attached to a patient's maxillary or mandibular bone material in order to secure the implant. The various interfaces between different materials used in an implant are often a weak link that results in fracture or dislocation of portions of the implant. What are needed therefore are ways of improving the properties of implant materials.

### SUMMARY

The present disclosure provides a material that is configured for implantation in a living organism. The material has a mechanical surface that has long range ordered micro-features. A further embodiment provides a material that is configured for implantation in a living organism, where the material has a mechanical surface that has a repetitive pattern of hierarchical micro-features. A method is provided for modifying the surface of a tissue in a living organism. The method includes a step of dividing a laser beam into a plurality of laser beams and a step of guiding the plurality of laser beams to create an interference pattern at the surface of the material, wherein a repetitive pattern of micro-features is formed on the surface of the tissue. A method is also provided for improving adhesion of a restorative material to tooth material. The method includes a step of modifying a surface of at least one of the restorative material, the dentin, and the enamel with a laser, wherein modifying the surface comprises at least one of composite formation and chemical restructuring.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a somewhat schematic cross-sectional view of dental crown and post installed in a human being.

FIG. 2 is a somewhat schematic view of principle for modification of a surface of a material configured for implantation and cross-sectional views of modifications.

FIG. 3 is a diagram of scales of size of hierarchical features on a structured surface.

FIGS. 4A and 4B are somewhat schematic cross-sectional views of repetitive patterns on the surface of a material configured for implant.

FIG. 5 is a photomicrograph of a surface of a ceramic material suitable for modification by laser interference structuring.

FIGS. 6-8 are photomicrographs of a portion of the surface of the ceramic material of FIG. 5 after modification by laser interference structuring.

FIGS. 9A, 9B, and 9C are schematic illustrations of repetitive patterns of micro-features fabricated on a material configured for implantation.

FIG. 10 is a flow chart of a method for modifying the surface of a tissue in a living organism.

FIG. 11 is a schematic diagram of a possible equipment set up for laser structuring.

FIG. 12 is a TEM micrograph of a cross-sectional view of a surface treated with laser interference structuring.

FIG. 13 presents TEM micrographs of laser-treated zirconia.

FIG. 14 presents electron micrographs of cross-sections of laser-treated zirconia.

FIG. 15 is a semi-logarithmic plot of laser fluence as a function of depth structure.

### DETAILED DESCRIPTION

In the following detailed description of the preferred embodiments, reference is made to the accompanying drawings, which form a part hereof, and within which are shown by way of illustration the practice of specific embodiments of a material configured for implantation in a living organism and embodiments of a method of modifying the surface of a tissue in a living organism. It is to be understood that other embodiments may be utilized, and that structural changes may be made and processes may vary in other embodiments.

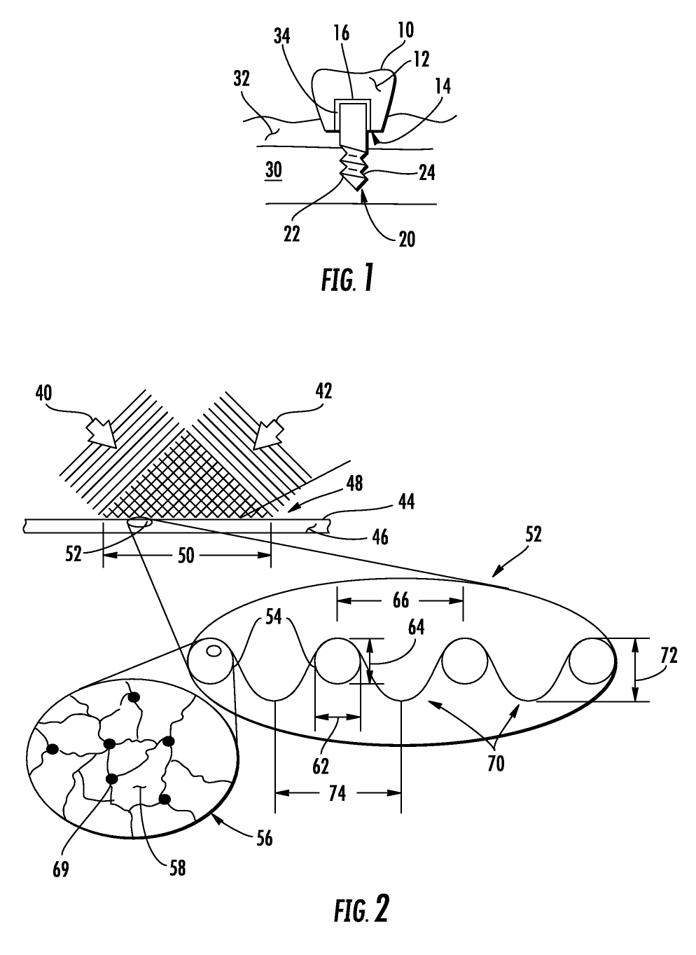

FIG. 1 illustrates two embodiments of a material configured for implantation in a living organism. As used herein, the term implantation refers to the act or process of fixing or securely setting a material in a living organism. The organism may be a plant or an animal, and in many embodiments the organism is a human being. The first material depicted in FIG. 1 that is configured for implantation in a living organism, in this case a human being, is a dental crown 10. The crown 10 is fabricated from a material 12 that typically may include alumina, zirconia, porcelain, or similar materials. The dental crown 10 has a hollow portion 14. The hollow portion 14 is configured to fit over a second embodiment of a material configured for implantation in a living organism, namely a titanium screw 20. In some alternative embodiments the titanium screw 20 may be replaced by a post, and in some embodiments the screw or post may be fabricated from an alternate biocompatible metal like 316L steel or from a ceramic like zirconia, alumina, porcelain (often feldspathic porcelain) or similar material. In further alternative embodiments the dental crown 10 may be configured to fit over a portion of the base of a human tooth.

The hollow portion 14 of the dental crown 10 has a mechanical surface 16. A “mechanical surface” refers to a surface that is configured to be disposed in contact with a material that is not live biological tissue. The titanium screw 20 has a threaded portion 22 that is configured for insertion in maxillary or mandibular bone material 30 that underlie and support a tooth in a human being. The threaded portion 22 of the titanium screw has a bio-interfacial surface 24. A “bio-interfacial surface” refers to a surface that is configured to be disposed in contact with live biological tissue (i.e., the bone material 30). A portion of the crown 10 and a portion of the titanium screw 20 are disposed in gum tissue 32. A thin bond of adhesive 34 may be used to bond the mechanical surface 16 of the crown 10 to the titanium screw 22.

After implantation the crown 10 is subjected to very high stress forces as it is compressed between other teeth and the titanium screw 14. While the thin bond of adhesive 34 may provide some stress relief, there may be voids in the adhesive 22 that place the crown 10 in direct contact with the titanium screw 14. Furthermore, even where there is adhesive 34 between the crown 10 and the titanium screw 14, the shear forces and the compression forces exerted at the mechanical surface 16 of the crown 10 may still be significant. To improve the material properties, typically including the flexure or fracture strength and adhesion, of the crown 14 a portion or all of the mechanical surface 16 of the crown 10 that is in contact with the adhesive 34 and/or with the titanium screw 20 may be modified with one or more embodiments described herein, which typically involve the application of laser interference structuring.

While the embodiment of FIG. 1 is directed toward dental applications, other embodiments may be directed toward other medical implant applications, such as joint replacement implants, implanted sensors, and structural supports such as bone screws, arterial stents, and so forth. Furthermore, some embodiments may be directed to modification of human tissue such as tooth enamel, dentin, cartilage, or bone.

Laser interference structuring systems typically employ a laser beam that is divided into two or more beams that are then guided by an optical system to interfere with each other at a sample surface. The standing optical wave describes a periodic intensity pattern. For example, a high-power laser beam may be divided into two or more coherent sub-beams and guided by an optical system that causes the sub-beams to interfere with each other on the sample surface. The angles between the beams define the two-dimensional interference fringe spacing in the intensity distribution. Spacing can be calculated for a two-beam interference experiment by employing the following formula:

$$d = \frac{λ}{2 sin ϕ} \qquad Eq ’ n 1$$

where φ is the angle between the two incident beams and λ is the wavelength of the light. While Equation 1 indicates that the spacing of the intensity distribution may be scaled down to half of the laser wavelength, the practical limit is typically from approximately 50 to 100 μm due to the equipment limitations. Interfering laser beams guided by an optical system yield variable structure possibilities and can be employed to create line-like structures and net-like protuberances with two or more planar arranged beams and dot-like structures with three or more non-planar incoming beams.

FIG. 2 illustrates an exemplary laser interference process and resultant surface modifications. A first laser beam 40 and a second laser beam 42 are directed at a surface 44 of a material 46, to form an interference pattern that produces a structured area 48. The surface 44 of FIG. 2 may, for example, be the mechanical surface 16 of the crown 10 of FIG. 1, or the surface 44 of FIG. 2 may be the bio-interfacial surface 24 of the titanium screw 20 of FIG. 1. Typically both the laser beam 40 and the laser beam 42 may be one or more pulses from a Nd:YAG laser, each typically from one up to approximately ten nanoseconds in duration. However in alternate embodiments other lasers may be used and pulses may range from femtoseconds, to over picoseconds, to nanoseconds, to milliseconds. The structured area 48 may be a structured area diameter 50 that may range from a few hundred micrometers to approximately 10 millimeters. The structured area diameter 50 may increase as laser power increases. With current-generation lasers the structured area diameter 50 is typically 5-8 mm. Next generation of lasers may provide sufficient power to increase the diameter to perhaps several centimeters or more.

A detailed segment 52 of the structured area 48 is depicted in FIG. 2 for illustrative purposes. The detailed segment 52 illustrates a series of hierarchical micro-structures 54. The hierarchical micro-structures 54 typically have a micro-structure width 62 that ranges from approximately one hundred nanometers to approximately ten micrometers in extent, and the hierarchical micro-structures 54 may have a micro-structure height 64 that ranges from approximately one hundred nanometers to approximately ten micrometers in extent. The hierarchical micro-structures 54 may have a spacing 66 that typically ranges from approximately one hundred nanometers up to approximately one hundred micrometers.

As used herein, the word “hierarchical” in the term “hierarchical micro-structure” refers to a micro-structure with features on a variety of different length scales ranging from mm over μm to nm. A length scale differences of an order of magnitude or larger is a sufficient difference to establish microstructures as “hierarchical.” In the embodiment of FIG. 2 the hierarchical micro-structures 54 have sub-features 56. The sub-features 56 include modified grain structures 58 that differ from the grain structure of other portions of the surface 44 of the material 46. The sub-features 56 also include densified inclusions 60. The sub-features 56 typically have a diameter that may range from approximately one tenth of a nanometer to approximately fifty nanometers.

The term “composite micro-structure” refers to a micro-structure that has sub-features defined by material property variations. Material property variations are variations in the material that result from physical or chemical variations. The modified grain structures 58 and the densified inclusions 60 of the hierarchical micro-structures 54 depicted in FIG. 2 are examples of sub-features defined by material property variations that are induced by composite formation processes. Oxidation, reduction, synthesis, decomposition, polymerization, and other chemically-reacted effects are also considered to be material property variations that are induced by chemical restructuring processes. Sub-features defined by dimensional variations are not considered herein to be material property variations.

The detailed segment 50 in FIG. 2 also illustrates a pattern of topographical micro-structures 70 that have a topography height 72 that typically ranges from approximately one nanometer to approximately ten micrometers. The topographical micro-structures 70 typically have a spacing 74 that typically ranges from approximately one hundred nanometers up to approximately one hundred micrometers. Topographical micro-structures may include topographical sub-features. Topographical sub-features are typically variations in topography height that range from approximately one nanometer to approximately ten micrometers. Topographical micro-structures, hierarchical topographical micro-structures, and hierarchical composite micro-structures are collectively referred to herein as micro-features. Micro-features are hierarchical if they have length scale differences of at least an order of magnitude. Hierarchical micro-features are hierarchical composite micro-features if the sub-features have length scale differences of at least an order of magnitude that are defined by material property variations.

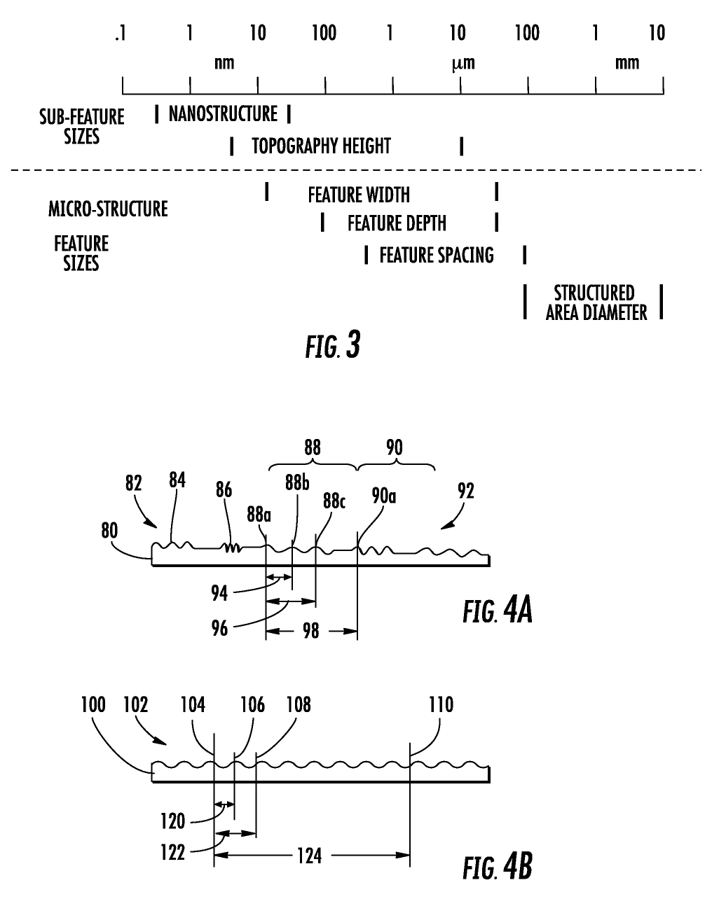

FIG. 3 illustrates typical relationships between sizes of material modifications described herein. When using laser structuring techniques the main controllable features are the periodicity and the volume of the feature generated. These features can be described by three main dimensions that are directly controllable. Furthermore, two additional sub-features can be characterized and indirectly controlled within certain limits. The three main features are:
micro-structure feature spacing, which is the distance between immediate neighboring heat affected/changed volumes (center to center);
micro-structure feature width, which is the lateral width of the immediate neighboring heat affected/changed volumes; and

micro-structure feature depth, which is the vertical thickness of the heat affected/changed volume below the unaffected surface.

The two sub-features are:
topography height, a topographic modulation on the surface, i.e. the height differences among various heat-affected and unaffected areas; and
nanostructure, a nano-crystalline structure within a micro-structure.

Feature Spacing—The different feature dimensions may be adjustable in their specific length limitations. Feature spacing is principally a function of the interference fringe spacing described earlier and it may generally be varied from approximately one hundred nanometers level up to approximately one hundred μm. Generally, the lowest physical length limit for the spacing of the interference fringe according to Equation 1 is half of the laser wavelength. This limit may be pushed down by changing the wavelength just above the sample. For this purpose, a prism may be attached to the material being processed. The wave traveling through this index-changing medium exits at a different speed compared to air or a vacuum. Therefore, the effective (new) wavelength is shorter, and the physical length limit may be pushed down to half of the new wavelength.

Typically for most materials half wavelength structuring cannot be achieved. Even in the case where the intensity distribution shows fringe spacing on the sub-micrometer scale, the lowest spacing length is limited by the heat transfer in the material. In metals, for example, the optical energy delivered is mainly converted into heat, which then follows the three-dimensional heat diffusion equation. The heat diffusion length depends on the interaction time of the laser with the material.

The heat diffusion length is defined as the distance from the heat source in which the temperature is lowered to the 1/e fraction of the initial temperature. This length grows with longer pulse duration and can be approximated with Equation 2.

$${l}_{diff} \approx 2 {( {τ}_{p} \frac{{κ}_{t}}{ρ {c}_{p}} )}^{1 / 2} \qquad Eq ’ n 2$$

where tₚ is the pulse duration or involved time regime; kₜ is the thermal conductivity of irradiated material; r is the density; and cₚ is the thermal capacity. The minimum feature size cannot be smaller than the periodicity of the intensity pattern or the diffusion length, whichever is greater.

In the case of ultra-short femto second (fs) laser pulses, Equation 2 predicts a limit which is much lower than half of the laser wavelength. Therefore, a feature spacing of half of the wavelength should be possible. Even in this case, however, a feature spacing equal to half of the laser wavelength may not be achieved in practice. Based on a special two-temperature model for fs-laser irradiation, an interaction time of up to 100 ps may be predicted, which is three orders of magnitude longer than the pulse itself. If one counts that as “pulse duration,” the diffusion length can be approximated at 200 nm (for copper).

Another issue based on the use of an fs-laser should generally be considered. According to the speed of light, a pulse in air with duration of about 100 fs has a length of about 30 μm. Therefore, the path length of each beam has to be precisely adjusted. It may be possible to address this requirement for precision by using an optical delay line in one of the beam paths. The theoretical limit could be pushed down even further by using shorter pulse duration. However, the interaction mechanisms change in that case, and the portion of thermalization in the lattice of provided optical energy drops dramatically. As a result, only a topographic texturing due to ablation may be possible.

Feature Width—In a second approximation, the laser fluence that is dependent on the power and the pulse length, along with the irradiated area, further influences the surface effects (surface features). The temperature field in such a process may be completely simulated with finite element analysis. The calculations for exact temperature fields will be more realistic, depending upon whether the primary physical effects such as radiation, convection, or photo-ablation are considered. Nevertheless, the three dimensional heat transfer equation based on Fourier's law of heat conduction may be used to estimate the periodic melting pool volume fraction for two interference fringes included in the calculations.

Feature Depth—The feature depth is defined to be the vertical thickness of the changed micro-structure or affected volume. A surface feature can be microstructurally and physically different from its surrounding volume of material, only if the ratio of surface feature size to interference fringe spacing is equal to or less than one. If this ratio is greater than one, i.e., a surface feature size larger than interference fringe size, it is likely to produce an array of surface features with partial overlap. Thus, for a given laser wavelength, the nature of surface features is influenced by the angle between interfering beams and the thermal conductivity of the material. The optimization of this ratio depends on the physical, chemical and microstructural characteristics to be generated within the feature that in turn will be dictated by the application.

Topography Height—Because it is dependent on the absorption mechanism, the surface topography is a result of laser ablation or materials transport due to melting and evaporation. In metals, the optical energy is primarily converted into heat that results in melting or evaporating the material. Therefore, it is possible somewhat independently to design the topography of the microstructural changes to be maximal, minimal or negligible compared to other structural parameters. As a result, the topography height may range from approximately one nanometer up to approximately ten micrometers.

Nanostructure—Feature size depends primarily on the amount of energy delivered to the surface and the cooling rate. Due to the locally delivered energy and extremely short time period, the cooling rates are in the order of about 10¹⁰ K/s. This is typically a very rapid process, but it is still slow enough for nucleation of grains. Therefore, laser structuring produces ultra-fine grained crystalline material at the locations of hot spots. Grains, precipitates, and particles are typically nanocrystalline. The size distribution of these features is periodic, with spacing ranging from 2 to 5 nm at hot spots to 1 μm or even more, corresponding to the initial grain size within the cold spots.

Micro-features that are formed on the surfaces of materials may exhibit either short-range ordered patterns or long-range ordered patterns. Short-range ordered patterns and long-range ordered patterns are collectively referred to as repetitive patterns. FIG. 4A illustrates a plurality of short-range ordered patterns. In FIG. 4A a material 80 has a surface 82 that includes a plurality of topographical variations, 82, 84, 86, 88, 90, and 92. Short-range ordered patterns are characterized by feature spacings that are constant only for a few adjacent features. For example features 88a, 88b, 88c and 90a are adjacent features. The spacing between a first feature, 88a and its nearest neighbor 88b is a pattern spacing distance 94. The spacing between the first feature 88a and (in one direction) its second-nearest neighbor 88c is a distance 96 that is substantially two times the pattern spacing distance 94. However the spacing between the first feature 88a and its third nearest neighbor 90a is a distance 98 that is not substantially three times the pattern spacing distance 94. Short-range ordered patterns may have feature spacings that are constant for more than two nearest neighbors, but generally not for more than about five nearest neighbors.

FIG. 4B illustrates a long-range ordered pattern. A material 100 has a surface 102 that includes a plurality of topographical variations, including features 104, 106, 108, and 110. The spacing between a first feature 104 and (in one direction) its nearest neighbor 106 is a pattern spacing distance 120. The spacing between the first feature 104 and its second-nearest neighbor 108 is a distance 122 that is substantially two times the pattern spacing distance 120. The spacing between the first feature 104 and its eighth-nearest neighbor 110 is a distance 124 that is substantially eight times the pattern spacing distance 120. Long-range ordered patterns may have constant spacing for 10, 100, 1000 or even more repetitions.

An important benefit of the laser interference structuring techniques disclosed herein is the ability to work at the molecular level, virtually atom by atom, to create larger structures with fundamentally new molecular organization. The behavior of structural modification features in the range of about one to one hundred nm exhibit important differences compared to the behavior of isolated molecules of about one nanometer or to the behavior of bulk materials. Among these differences are increased elastic modulus, strength, and resistance to fatigue fracture. An advantage of nanostructured materials is that their bulk properties can easily be fine-tuned by small modifications of various building blocks, such as a monomer. Laser treatment may be used for chemically and physically restructuring the restorative material surface and for composite formation in order to enhance adhesion and to improve the materials' lifetime. It is particularly beneficial to periodically restructure and chemically alter the materials with a lateral long-range ordered composite structure, providing improved chemical bonding behavior with optimized hydrophilic/hydrophobic properties and high stiffness while retaining a high degree of toughness. These structural biomaterials typically have superior mechanical properties such as toughness and wear compared to other standard materials.

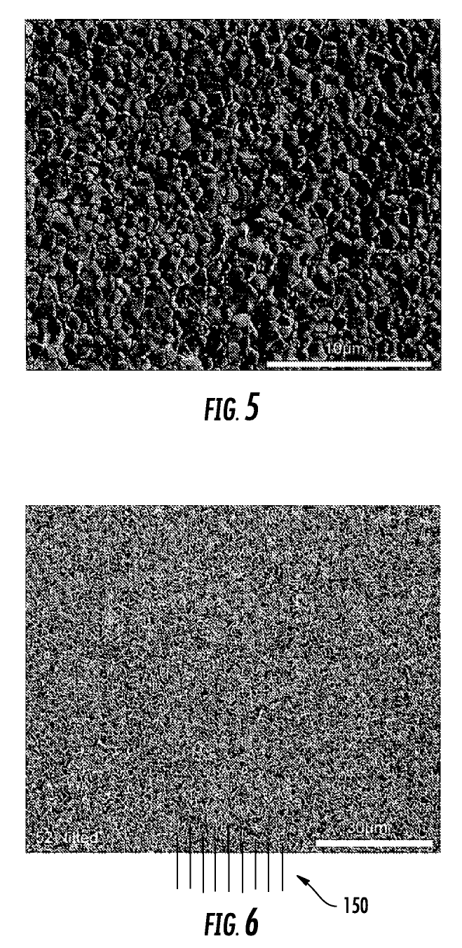

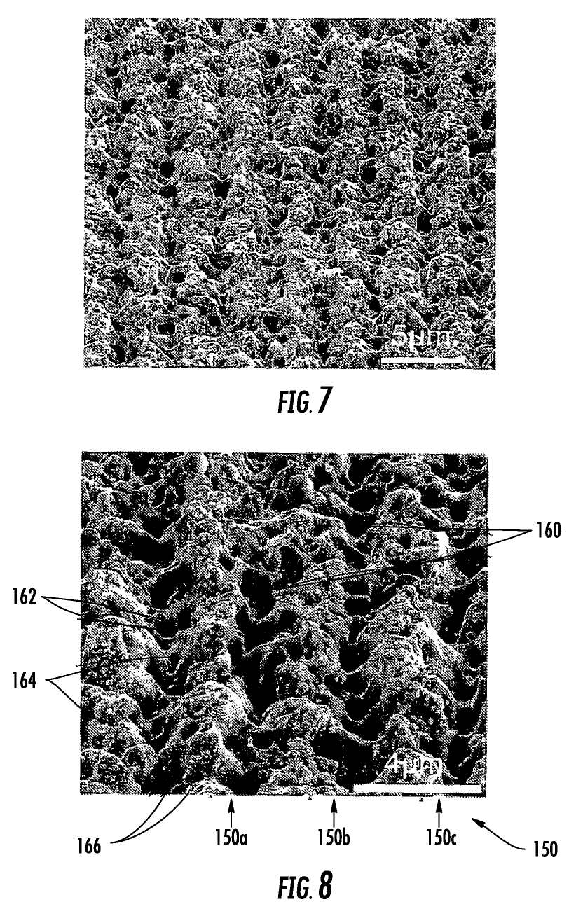

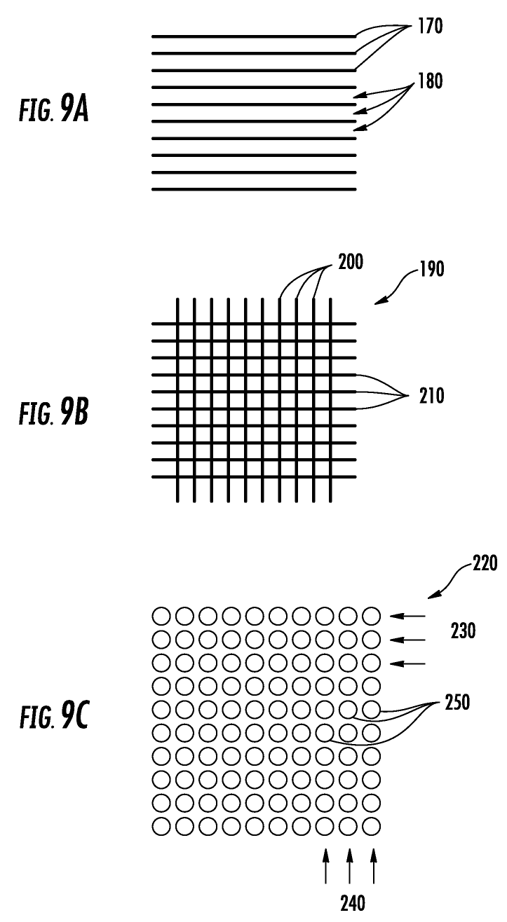

FIG. 5 illustrates a ceramic substrate prior to modification by laser interference structuring. FIGS. 6, 7, and 8 illustrate different magnifications of the substrate of FIG. 5 after modification by laser interference structuring. FIG. 6 illustrates a pattern of long-range ordered micro-structures 150. FIG. 7 illustrates the long-range ordered micro-structures of FIG. 5 at a higher magnification. FIG. 8 depicts that the long-range ordered micro-structures 150 at a higher magnification than FIG. 7, and illustrates that the micro-structures 150 are at least in part topographical micro-structures having a feature spacing of approximately 4 micrometers. Specific ridge features 150a, 150b and 150c are identified. As previously indicated, topographical micro-structures are a form of micro-features, so the ridge features 150a, 150b, and 150c represent long-range ordered micro-features. Each of the micro-structures, such as micro-structure 150c has sub-features, some of which for micro-structure 150c are identified as sub-features 160, sub-features 162, sub-features 164 and sub-features 166.

Sub-features 160 are large pores. Sub-features 162 are medium-size pores. Sub-features 164 are nano-pores or nano-protrusions. Sub-features 166 are nano-particles or nano-droplets. By virtue of inclusion of these sub-features that have length scale differences of at least an order of magnitude the long-range ordered micro-structures 150 are also categorized as long-range ordered hierarchical micro-structures. Furthermore, by virtue of the inclusion sub-features 166 (nano-particles or nano-droplets) the micro-structures 150 are also characterized as long-range ordered hierarchical composite micro-structures.

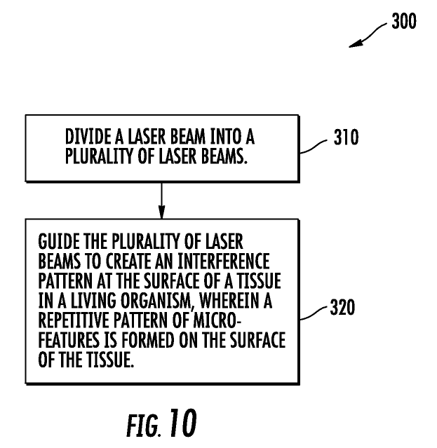

As previously indicated, laser interference structuring techniques may be used to create line-like structures and net-like protuberances with two or more planar arranged beams and dot-like structures with three or more non-planar incoming beams. FIGS. 9A, 9B, and 9C illustrate some of the possibilities. FIG. 9A illustrates a repetitive pattern of first line-like structures 170. The first line-like structures 170 may be topographical peaks, or locally densified regions, or other micro-features. FIG. 9A also illustrates a repetitive pattern of second line-like structures 180. The second line-like structures 180 may be topographical valleys or locally untreated regions. FIG. 9B illustrates a net-like structure 190. The net-like structure 190 includes a first repetitive pattern of line-like structures 200 and a second repetitive pattern of line-like structures 210. The first repetitive pattern of line-like structures 200 is disposed at a non-zero angle (in this case disposed at an orthogonal angle) to the second repetitive pattern of line-like structures. The first repetitive pattern of line-like structures 200 and the second repetitive pattern of line-like structures 210 are an example of two angulated repetitive patterns of micro-features. The first repetitive pattern of line-like structures 170 and the second repetitive pattern of line-like structures 180 in FIG. 9A are not angulated repetitive patterns of micro-features because they are parallel to each other (i.e., not disposed at a non-zero angle to each other).

FIG. 9C illustrates dot-like structures 220. The dot-like structures 220 may be characterized as a first repetitive pattern of dot-like structures 230 disposed at a non-zero angle (in this case disposed at an orthogonal angle) to a second repetitive pattern of dot-like structures 240, even though each individual dot 250 is attributed to both the first repetitive pattern of dot-like structures 230 and the second repetitive pattern of dot-like structures 240. By virtue of this perspective the first repetitive pattern of dot-like structures 230 and the second repetitive pattern of dot-like structures 240 are an example of angulated repetitive patterns of micro-features.

Some embodiments employ laser interference structuring to modify the surface of animal tissue, such as human gum, tooth material (i.e., dentin or enamel), or maxillary or mandibular bone material. Typically such modification is a long-range ordered micro-structure pattern, and it may be hierarchical, and it may include composite micro-structures. Such modifications may, for example, strengthen the tissue, provide boding sites having improved adhesion properties, or inhibit degradation of the surface by chemicals or micro-organisms. FIG. 10 is a flow chart 310 for a method embodiment. In a first step 310, a laser beam is divided into a plurality of laser beams. In a second step 320, the plurality of laser beams is guided to create an interference pattern at the surface of a tissue in a living organism, wherein a repetitive pattern of micro-features is formed on the surface of the tissue. In some embodiments the method includes a method for modifying the surface of tissue adjacent to an anatomical location of a tooth in a human being. The anatomical location of a tooth is an area adjacent a tooth socket or, in the case of extensive reconstructive surgery, the anatomical location of a tooth is an area adjacent where a tooth socket is being re-constructed. In some embodiments the method includes a method for modifying the surface of the tissue to provide a plurality of angulated repetitive patterns of micro-features.

### EXAMPLE

As a demonstration of some of the embodiments described herein, tape cast pseudo-cubic zirconia pellets were surface irradiated by two coherent interfering high-power short pulse Nd:YAG laser beams. The interfering beams of the third harmonic with a wavelength of 355 nm of a 2.5 ns Q-switched laser produced an instant line-like intensity distribution with a periodic distance of 3.3 μm due to the selected angle in between the beams. The resulting microstructure consisted of ultra-fine grained zirconia with a grain size of about 10 nm within the top 100-200 nm depth of the treated surface region. The depth limitation is due to the generally high cooling rates during short pulse laser processing (up to 1010 K/s). The surface morphology closely followed the micro-periodic heat treatment provided by the interfering laser beams. The pore size distribution within the periodic surface morphology ranged from a few nanometers to a maximum of half of the periodic line distances.

At low temperature, pure zirconia exists as a monoclinic equilibrium crystal structure that changes to tetragonal at 1170° C., to cubic at 2370° C., and melts at 2680° C. Yttria partially stabilized zirconia (PSZ) lowers the low temperature stability of tetragonal zirconia to close to 500° C. at 1.4 mol % yttria. Tetragonal zirconia is used for many mechanical applications due its high strength compared to the cubic phase. In fully stabilized zirconia (FSZ) with 8 or more mol % yttria, the cubic phase is fully stabilized at room temperature and shows no phase transformations up to the melting point at about 2,740° C. This effort was focused on the laser surface treatment of FSZ primarily for studying morphological and micro-structural changes. Such a morphological treatment was performed with a laser-based interference technique. A two-beam interference configuration was employed to provide high speed periodic temperature treatment with a line-like intensity distribution. Effects of the treatment on fully stabilized zirconia were evaluated for surface composition changes including possible loss of yttria and corresponding crystallographic phase changes under such high speed thermal treatment.

Cast tapes were fabricated from high purity, fully stabilized 8 mol % yttria stabilized zirconia powder (Tosoh). Pellets were stamped from the tape and sintered at 1350° C. for 2 hours. The resulting pellets were greater than 91% of theoretical density. The pellets were laser surface-treated under various sets of processing parameters. The linear polarized third harmonic of a q-switched Nd:YAG laser (Coherent Infinity) with a wavelength of 355 nm, a pulse duration of about 2.5 ns, a repetition rate of 10 Hz, a maximum pulse energy of 150 mJ, and a maximum pulse power of 110 MW was used to treat the material surface. The primary laser beam was split into two coherent sub-beams and guided by an optical system to produce interference at the sample surface. A detailed set-up schematic is shown in FIG. 11. The area affected by the laser was measured to be approximately A=0.24 cm². A selected number of readings for laser fluence, F, were made at the sample surface with an external (portable) power meter to calibrate the internal power meter of the laser which continuously measured the pulse energy, E₀, at the fundamental wavelength of 1064 nm. The following relationship (Equation 3) developed through the calibration efforts provided the laser fluence at the sample surface for various power values.

$$F \approx \frac{0.499 {E}_{0} - 25.5 mJ}{A} \qquad Eq ’ n 3$$

The fluences for two laser beams were measured individually that indicated a close to 1:1 energy ratio. Two interfering laser beams create a sinusoidal intensity distribution with high and low intensity lines. The distance of the high intensity spots (periodicity) may be varied by the angle between the sub-beams according to the Bragg law. In this example, such distance was maintained constant at 3.3 μm. The laser fluence was varied from 315-951 mJ/cm² while the number of pulses was varied from 1 to 20 pulses with a constant repetition rate of 10 Hz. Selected number of treatments were also conducted with the laser beam at the fundamental wavelength of 1064 nm and pulse power of 600 mJ (1260 mJ/cm²). This treatment affected a larger volume which was useful to perform transmission electron diffraction analysis to distinguish between changed and unchanged areas.

The morphology of the surface was characterized using optical microscopy. The phase microstructure was analyzed using X-ray diffraction (XRD) (PANalytical X'Pert with Cuₖₐ₁ radiation; 45 kV and 40 mA) in symmetric as well as grazing incidence angle in order to monitor only the top surface layer. TEM (Hitachi HF2000 Field emission) and focused ion beam (FIB) microscopy (FEI Nova 200 Dual Beam System) were used to study the microstructure and the surface morphology in more detail at high resolution. TEM samples were prepared in cross-sections perpendicular to the line-like structure with a single beam FIB (Hitachi, FB-2O00).

The surface morphology significantly changed due to the laser interference structuring treatment compared to surface morphology of the as-sintered sample. Optical microscopy revealed a homogenous surface morphology within the laser structured region (FIGS. 5, 6, 7, and 8). The randomly rough surface with its non-uniform grain structure in the as-sintered sample was transformed into an orderly (periodic) line-like morphology that contained open microporosity in laser surface treated samples. The pore size ranged from a few nanometers up to about the half of the periodic line distance (1.6 μm). On the peaks (crest) of the line-like structure nanoparticles can be observed (FIG. 8).

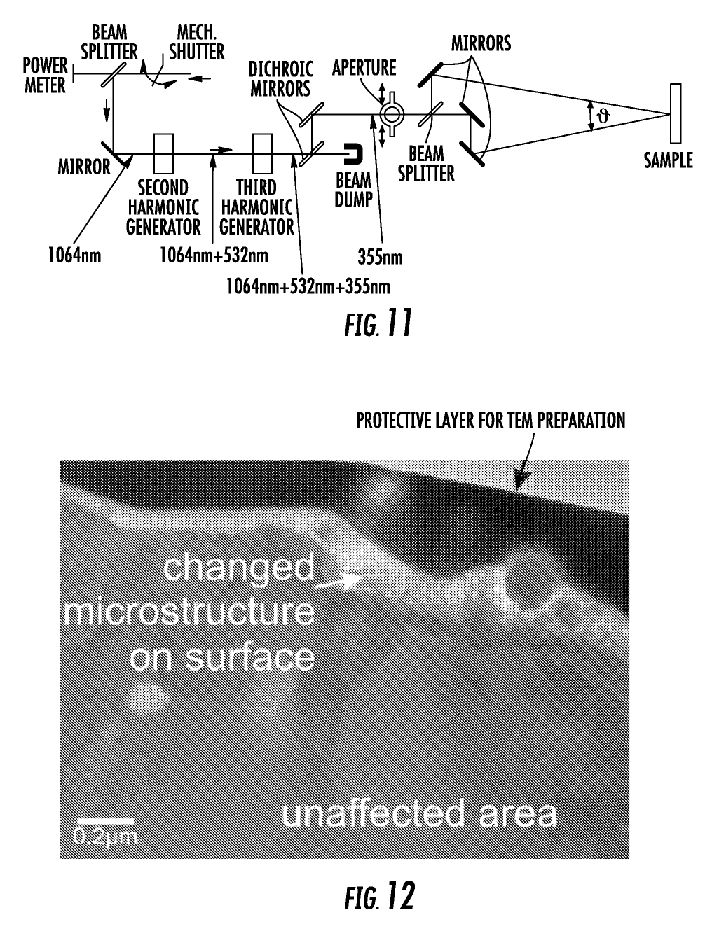

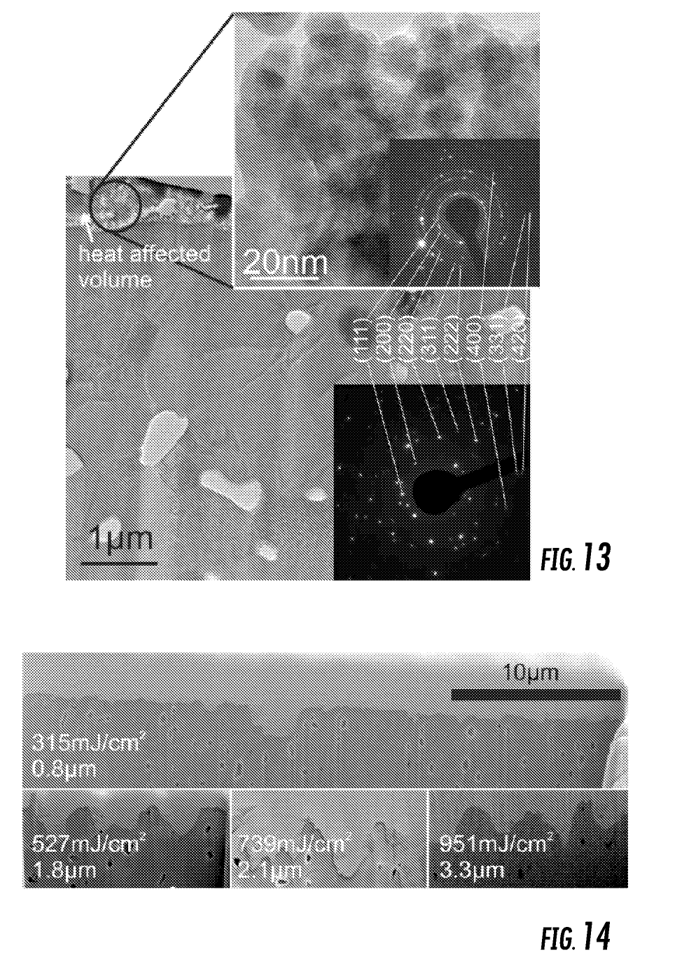

XRD analysis indicated the absence of any detectable phase transformation within laser-irradiated surface region. TEM micrographs (FIG. 12) show that the initial grain size of 2-3 μm on the surface was reduced to 10 nm without initiating phase transformations. This change was confined only to the top ˜200 nm deep surface layer treated with the third harmonic. As mentioned earlier, TEM samples were prepared from the samples treated with the laser beam at the fundamental wavelength (1064 nm) and fluence of 1260 mJ/cm². Due to the higher available pulse energy, this treatment generated sufficient depth and volume of modified material for a small aperture selected area diffraction (SAD) analysis. Such analysis indicated a grain refinement within a depth up to 500 nm (FIG. 13). Furthermore, the electron diffraction images showed no phase transformation confirming the earlier findings of the XRD analysis.

The depth evolution or height of laser structured line peaks was analyzed in cross sections (FIG. 14) prepared by the dual beam FIB technique. The depth increased from 0.8 μm for 20 pulses with 315 mJ/cm² to 3.3 μm for 20 pulses with 951 mJ/cm² corresponding to an increase in the aspect ratio from 0.24 to 1, respectively (FIG. 14). If the structure depth z can be fitted to be a linear function of the logarithmic display of the fluence F(z) used for the creation of the structure, the main energy transformation mechanism is of photo-chemical nature. Thus, the threshold fluence F₀ and effective absorption coefficient a can be calculated based on the Lambert law using Equation 4.

F(z)=F₀exp(αz) Eq'n 4

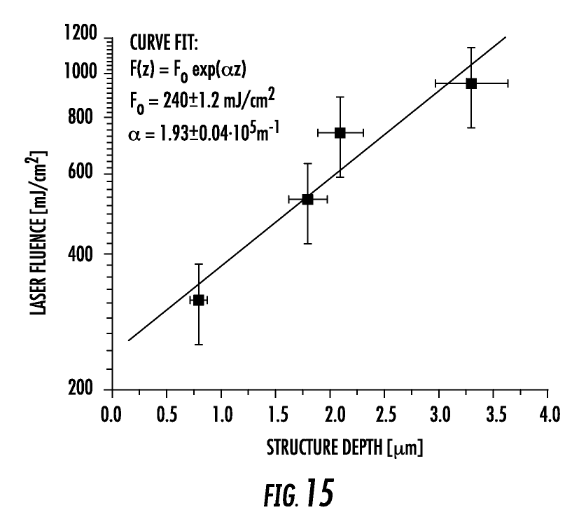

The ablation behavior can be well fitted with this equation as shown in FIG. 15. A threshold fluence, F₀=240±1.2 mJ/cm², an effective absorption coefficient, a=1.93±0.04·10⁵m⁻¹, and an optical penetration depth, Iₐ≈5.2 μm may be obtained.

As shown in FIG. 15 and calculations made using Equation 4, the main absorption mechanism in the samples processed using the parameters employed in the present study is of photo-chemical type. However, as mentioned earlier, the generation of a heat affected zone and evolution of microstructure indicated that in case of thermal insulators along with the typical photo-chemical mechanism, a photo-thermal mechanism also exists during processing. This combination is called photo-physical.

Short pulse laser surface treatments on low conductive ceramics are associated with the generation of thermodynamic conditions far from equilibrium. Such extreme thermodynamic conditions are known to produce novel and non-equilibrium phases and microstructures without changes in chemical compositions even for thermodynamically stable phases. Since both XRD and electron diffraction analysis did not reveal phase transformations (FIG. 13), it is believed that the processing parameters employed in the present efforts neither generated non-equilibrium phase transformations nor changed chemical composition through a potential loss of yttria. The top surface layer appeared to have melted during the laser treatment due to a photo-thermal activation. Therefore, the temperature within the high (maximum) laser intensity location of interference pattern on the sample surface rose above the melting point of cubic zirconia (>2,700° C.) thereby melting the material periodically followed by confined solidification in corresponding periodic regions. The depth of the melt pool cannot be higher than the depth of volume of refined grain region because the ultra-fine grain material stems from a re-solidification process.

Short pulse laser processing is known to be associated with extremely high cooling rates and therefore produce ultra-fine grain material through high nucleation and low growth rates. In some metallic cases cooling rates of up to 10 K/s have been confirmed. In the present case, the grain refined volume is confined to a depth of 100 to 200 nm as seen in FIG. 13. Typical grain morphology described above resulting from melting and solidification can be found not only confined to the regions corresponding to the high intensity interference spots of the periodic laser treatment but it is also present throughout the treated surface region. The following two possible reasons responsible for this observation can be identified. Either the temperature rose up to the melting point even at the laser interference minima or the molten material flowed over at least half a periodic line distance.

The two laser sub-beams showed nearly the same intensity right before interfering on the sample surface as measured with an external portable power meter. Thus, a laser intensity of close to zero is realized at the laser intensity minima (the points of destructive interference). A temperature rise, therefore, must be fully accounted for a thermal diffusion from the high intensity spots (the points of constructive interference) to the low ones. With the 3.3 μm distance between the centers of two consecutive high intensity spots, the heat diffusion length, l_{H}, must be at least 1.65 μm to create a high enough temperature rise. The diffusion length describes the spatial 1/e-decay in the temperature distribution. For directional heat flow problems it can be approximated employing the heat diffusivity, D, and the laser beam dwell time (pulse duration), tₚ, as shown in Equation 4.

l_{H}≈2\sqrt{Fτₚ} Eq'n 5

To accomplish this minimum heat diffusion length for a 2.5 ns laser pulse, the diffusivity of the irradiated material must be at least about 4.36·10⁻³ m²/s. However, yttria stabilized zirconia of varying yttria contents have heat diffusivities in the order of 10⁻⁶ m²/s which is 2.5 orders of magnitude lower than required for attending the minimum heat diffusion length of 1.65 μm. Therefore, melting of material at a laser intensity minimum can be ruled out and the melting morphology at these points must have resulted from flow of molten material from the surrounding high laser intensity region. Such periodically distributed melting pools locally generate a high partial pressure. In addition, the wave impact due to incoming laser pulse results in a plasma formation followed by generation of shock wave that also results in creation of high local pressure. Furthermore, due to the interference pattern this phenomenon exists at numerous locally confined periodic points. This ultimately leads to a large difference between the pressures at locations of laser maximum and minimum. As the melting pools exist on the free surface the molten material is free to move. Under the forces of high pressure, therefore, molten material can move with high velocity from a hot spot (creating valley) to a cold spot (creating peak).

Furthermore, the valleys-peak distance of laser line-like structure (morphology) is much higher than the heat affected zone and still can not be fully explained by the sole mechanism of material flow. On the contrary, this observation can only be explained by a combined phenomenon of ablation and heating. It seems that the material mainly gets photo-chemically ablated creating a high morphological aspect ratio and photo-thermally heated to a much lower extent creating a very small volume of melting and re-solidification microstructure. Therefore, the structure evolution follows Equation 4 as shown in FIG. 15. This also complements the generally accepted photo-physical mechanism with a large photo-chemical portion for energy transformation of an electromagnetic wave impact in the ns-regime on low conducting ceramics.

Finally, the existence of open porosity and micro-morphology can be explained as following. The melt pool material possesses a high surface tension with the tendency to form fine droplets (see nano-particles in FIG. 8) similar to that can be found in other cases such as periodically melted silicon. The tape-cast zirconia used in the present study was inherently a material with a closed porosity. Therefore, during laser interference surface treatment pores were either set free or captured within the material while it was being solidified. Additionally, a penetrating laser heat source with an optical penetration depth lₐ>l_{H} can cause overheating and bubble formation leading to explosive melt ejection. As pointed out earlier, if we approximate the diffusivity zirconia to 10⁻⁶ m²/s, the heat diffusion length, l_{H}, is in the order of 100 nm. On the contrary, the optical penetration depth, lₐ, calculated using Equation 4 is about 5.2 μm. Thus, the maximum temperature, and therefore overheating can occur in the region below the surface to create additional pores as mentioned above. This leads to a pore creation and evolution during the structuring process and creates micro-nano size droplets along with pores of maximum size of half of the size of periodic line structure (morphology). The size of the periodic line structure, therefore, controls the maximum size of open pores on the treated surface.

Tailored surface morphology with controlled microstructure (grain and porosity sizes) on a micro/nano scale is possible by the laser interference technique employed in the present work.

Laser interference direct structuring or laser interference metallurgy is a suitable tool for a defined micro-periodic high speed thermal treatment of zirconia. With the chosen line-like surface structure size, the surface pore size distribution can be well controlled and ultra-fine grains can be generated. Under the set of laser processing parameters employed in the present work the fully stabilized zirconia did not experience a loss of yttria during the laser processing. Therefore, no phase transformation occurred and the materials remained stable over the course of the structuring. The heat affected zone with refined microstructure was much smaller than the height of evolved line-like structure confirming the validity of the concept of photo-physical energy conversion in low conducting ceramics as zirconia.

In summary, embodiments disclosed herein include a material configured for implantation in a living organism and a method of modifying the surface of a tissue in a living organism.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A material configured for implantation in a living organism, the material comprising a mechanical surface having long range ordered micro-features.

2. The material of claim 1 wherein the material is configured for implantation as a dental material.

3. The material of claim 1 wherein the mechanical surface has a plurality of angulated repetitive patterns of micro-features.

4. The material of claim 1 wherein the mechanical surface has long range ordered hierarchical micro-features.

5. The material of claim 4 wherein the material is configured for implantation as a dental material.

6. The material of claim 4 wherein the mechanical surface has a plurality of angulated repetitive patterns of micro-features

7. The material of claim 1 wherein the mechanical surface has long range ordered composite micro-structures.

8. The material of claim 7 wherein the material is configured for implantation as a dental material.

9. The material of claim 7 wherein the mechanical surface has a plurality of angulated repetitive patterns of micro-features.

10. The material of claim 1 wherein the surface includes long range ordered hierarchical composite micro-structures.

11. The material of claim 10 wherein the material is configured for implantation as a dental material.

12. A material configured for implantation in a living organism, the material comprising a mechanical surface having a repetitive pattern of hierarchical micro-features.

13. The material of claim 12 wherein the material is configured for implantation as a dental material.

14. The material of claim 12 wherein the mechanical surface has a plurality of angulated repetitive patterns of micro-features.

15. The material of claim 12 wherein the mechanical surface has short range ordered hierarchical composite micro-structures.

16. The material of claim 15 wherein the material is configured for implantation as a dental material.

17. The material of claim 15 wherein the mechanical surface has a plurality of angulated repetitive patterns of micro-features.

18. A method of modifying the surface of a tissue in a living organism, the method comprising:
(a) dividing a laser beam into a plurality of laser beams;
(b) guiding the plurality of laser beams to create an interference pattern at the surface of the material, wherein a repetitive pattern of micro-features is formed on the surface of the tissue.

19. The method of claim 18 wherein the method comprises modifying the surface of tissue adjacent to an anatomical location of a tooth in a human being.

20. The method of claim 18 wherein the method comprises modifying the surface of the tissue to provide a plurality of angulated repetitive patterns of micro-features.

21. A method for improving adhesion of a restorative material to tooth material comprising:
modifying a surface of at least one of the restorative material, the dentin, and the enamel with a laser, wherein modifying the surface comprises at least one of composite formation and chemical restructuring.

22. The method of claim 20, wherein modifying the surface comprises a hierarchical structure a width between approximately one hundred nanometers and approximately ten micrometers and a height between approximately one hundred nanometers and approximately ten micrometers.

23. The method of claim 20, wherein the restorative material comprises at least one of a metal, a polymer, and a ceramic.
